(19) United States
(12) Patent Application Publication
(10) Pub. No.: US 2006/0224951 A1
(43) Pub. Date: Oct. 5, 2006

(54) Multiple window browser interface and system and method of generating multiple window browser interface

(75) Inventors: Eric Paul Burke, Northville, MI (US); Viraj Chavan, Sunnyvale, CA (US)

Correspondence Address: GREENBERG TRAURIG, LLP, MET LIFE BUILDING, 200 PARK AVENUE, NEW YORK, NY, 10166, US

(73) Assignee: Yahoo! Inc.

(21) Appl. No.: 11/254,126

(22) Filed: Oct. 19, 2005

Related U.S. Application Data
(60) Provisional application No. 60/666,532, filed on Mar. 30, 2005.

(51) Int. Cl. G06F 17/00

(52) U.S. Cl. 715/513

(57) ABSTRACT

A browser plug-in application provides functionality to allow the creation of a multiple window browser interface environment. By way of example, when the plug-in is activated, each time a user selects a URL to retrieve a new web document, the plug-in displays a new browser window in addition to the existing browser window within a single instance of the web browser application, as opposed to displaying the new browser window in place of the existing browser window. The plug-in, thus, permits users to dynamically view multiple web documents in a side-by-side or tiled fashion in a single instance of the browser application.

### CROSS-REFERENCE TO RELATED APPLICATIONS

This application claims benefit of U.S. Provisional Application Ser. No. 60/666,532, filed Mar. 30, 2005, entitled MULTIPLE WINDOW BROWSER INTERFACE AND SYSTEM AND METHOD OF GENERATING MULTIPLE WINDOW BROWSER INTERFACE, which is hereby incorporated herein by reference.

### BACKGROUND OF THE INVENTION

1. Field of the Invention

The present invention is in the field of Internet/web browser technology and, in particular, to a multiple window browser interface and improved system and method for generating the same.

2. Description of the Related Art

Presently, browser applications, such as Netscape Navigator and Microsoft Internet Explorer, provide functionality for users to receive content via the World Wide Web (referred to herein as the “web”) or the Internet. As is well known in the art, browser applications typically provide a graphical user interface (or GUI) that enables users to view text or graphic based web sites.

FIGS. 1-3 depict prior art browser GUIs. In FIG. 1, for example, a browser application generates a browser GUI 5 on the user's computer. The browser GUI 5 includes a main window 10 for displaying content retrieved from web sites via the web or Internet. The browser GUI 5 may also include one or more application toolbars 12, 14. Toolbar 12 provides access to the browser application's menu. Toolbar 14 provides graphical icons 14a that are shortcuts to functions in the browser application's menu.

By selecting the “search” button 16 located in toolbar 14, a search window 20 can be opened. As shown in FIG. 1, main window 10 and search window 20 are displayed as side-by-side frames separated by a vertical stile 22 that may be moved along a horizontally to resize the respective windows 10, 20. Other than resizing the windows 10, 20 neither the side-by-side relationship nor the position of the windows 10, 20 can be changed by the user.

Moreover, as shown in FIGS. 2 and 3, the search window 20 is used to perform web searches by entering a search term in an input box 24—in this example, “Albert Einstein”. The results 26 of the search are displayed in the search window 20. When one of the search results 6 in the form of a Uniform Resource Locator (URL) is selected, the web site linked to by the search result URL 26 is displayed in main window 10, as shown in FIG. 3. A drawback of using the search button functionality is that only web searches can be performed in the search window 20 and the search window 20 can only display search results. Thus, the search button functionality has limited use. Furthermore, every time a result is clicked in the search window 20, the information displayed in the main window 10 is changed and the new website displayed in place of the prior site. Thus, a user cannot compare the results from more than one web site at a time without manually opening a new instance 30 of the browser application 5, as shown in FIG. 4.

Consequently, there is a long felt, but unresolved, need for a system and method that dynamically displays multiple windows in the browser interface and thereby improves the web browsing experience for the end user.

### SUMMARY OF THE INVENTION

A multi-window plug-in application executable on a computer and operable with a browser application having an interface portion for displaying a first electronic document retrieved from a remote source generally comprises a software module stored on a memory of a computer and executable in one embodiment to operate as a plug-in to the browser application to, in response to a request for a receive a second electronic document, generate programming code to cause the browser application to display the first electronic document in a first division of the interface portion of the browser application and the second electronic document in a second division of the interface portion of the browser application.

Further, a method of comparing a plurality of electronic documents of a search result retrieved by a browser application and displayed in an interface comprises providing a browser plug-in application operable with the browser application for controlling the interface of the browser application, receiving a first request to retrieve a first electronic document of the plurality of electronic documents corresponding to a first link listed in the search result, receiving a second request to retrieve a second electronic document of the plurality of electronic documents corresponding to a second link listed in the search result, and generating browser readable programming code to display each of the search result, the first electronic document, and the second electronic document in the interface of the browser application. Additional features and advantages of the system are described further below.

### BRIEF DESCRIPTION OF THE FIGURES

FIGS. 1-3 depict screen shots of the prior art use of the search functionality provided by the Microsoft Internet Explorer browser;

FIG. 4 depicts a screen shot of a two instances of the Microsoft Internet Explorer browser;

FIGS. 5a-5d are screen shots of illustrative multiple window browser interfaces;

FIG. 6 is an illustrative process flow for generating a multiple window browser interface;

FIG. 7 is a schematic of the preferred elements of a single window within the multi-window interface; and

FIG. 8 is a screen shot of an illustrative multiple window interface utilizing floating frames.

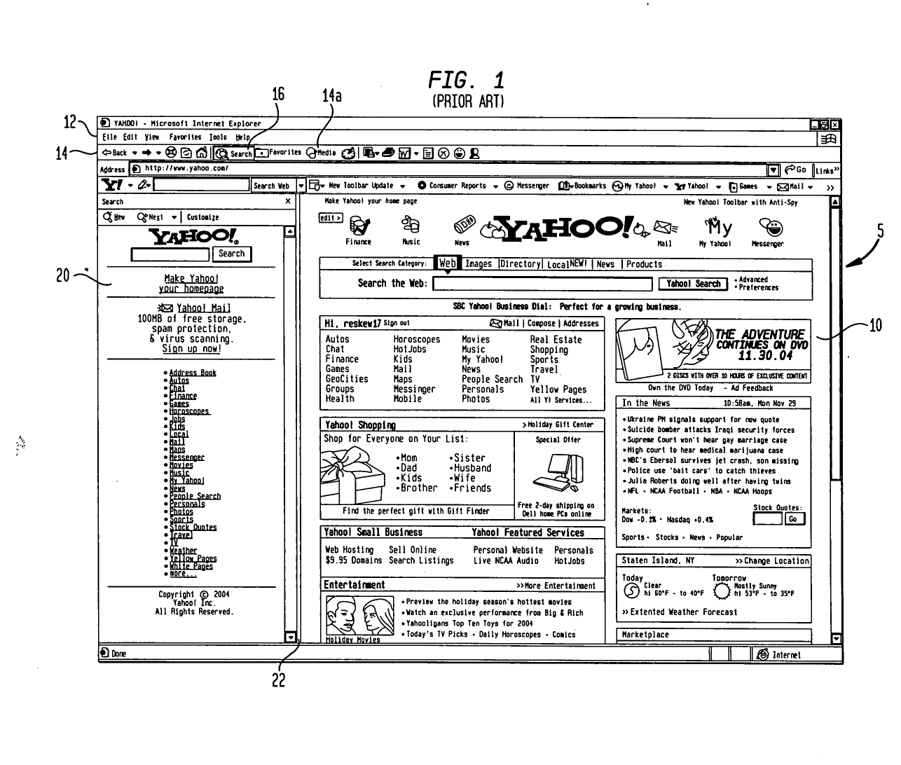

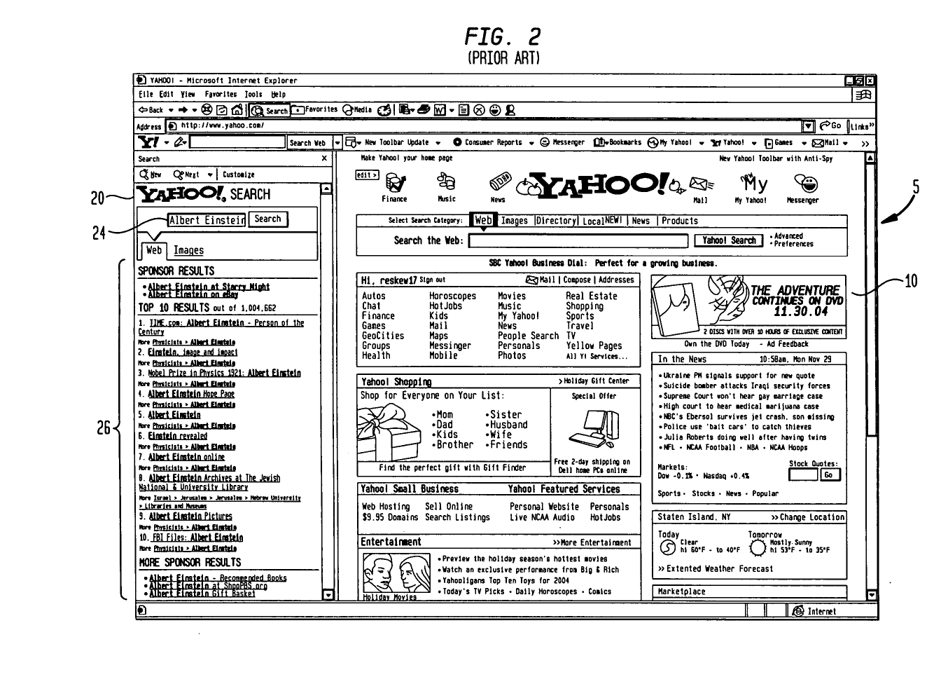

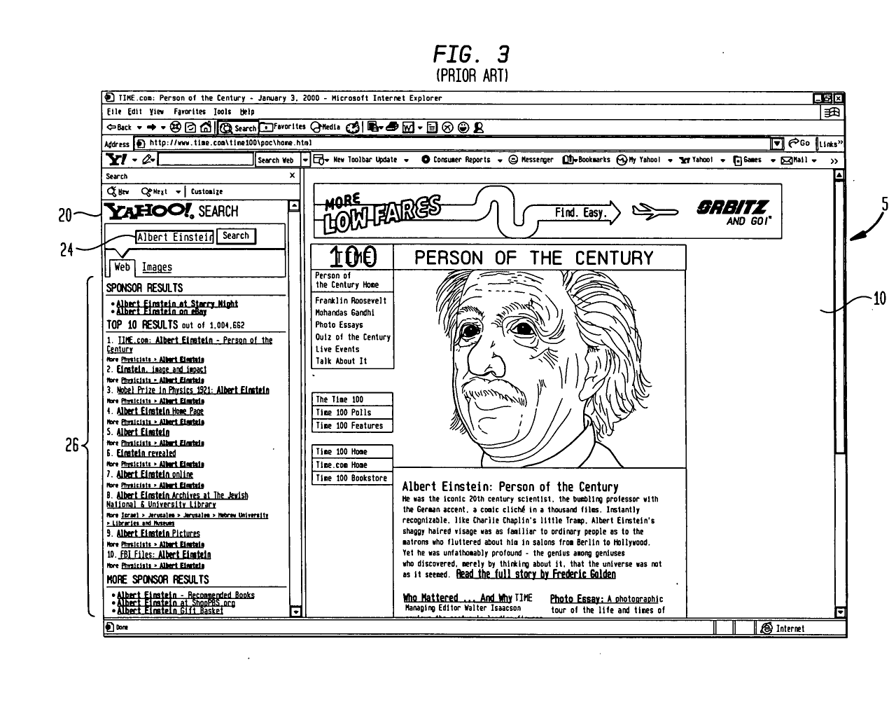

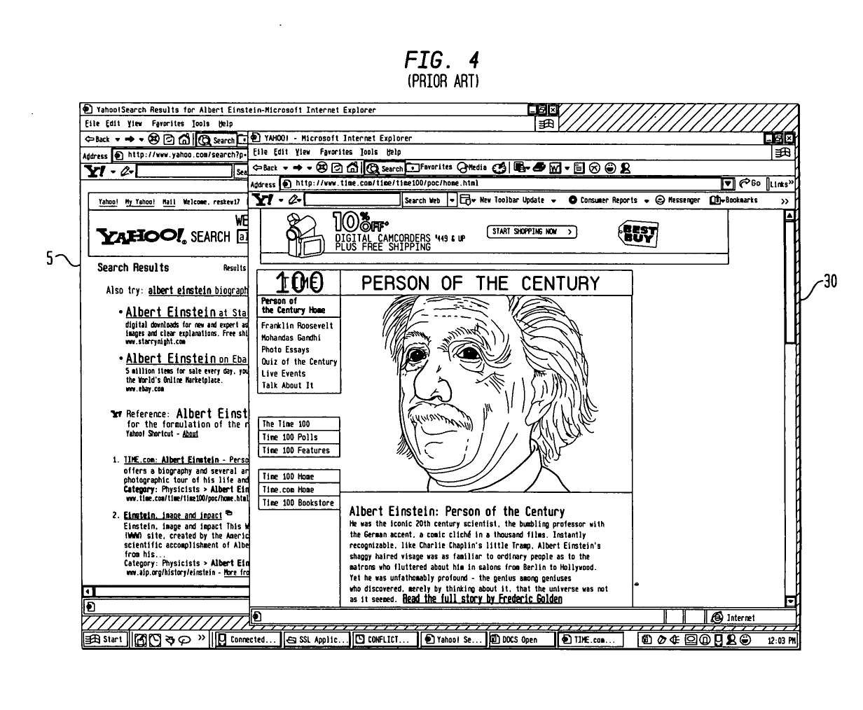

### DETAILED DESCRIPTION OF THE EMBODIMENTS

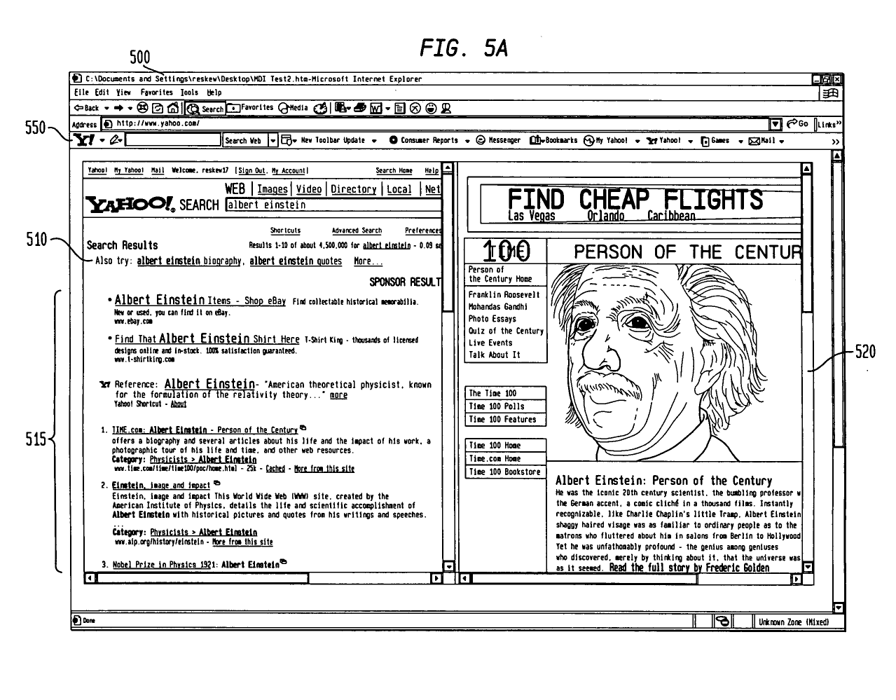

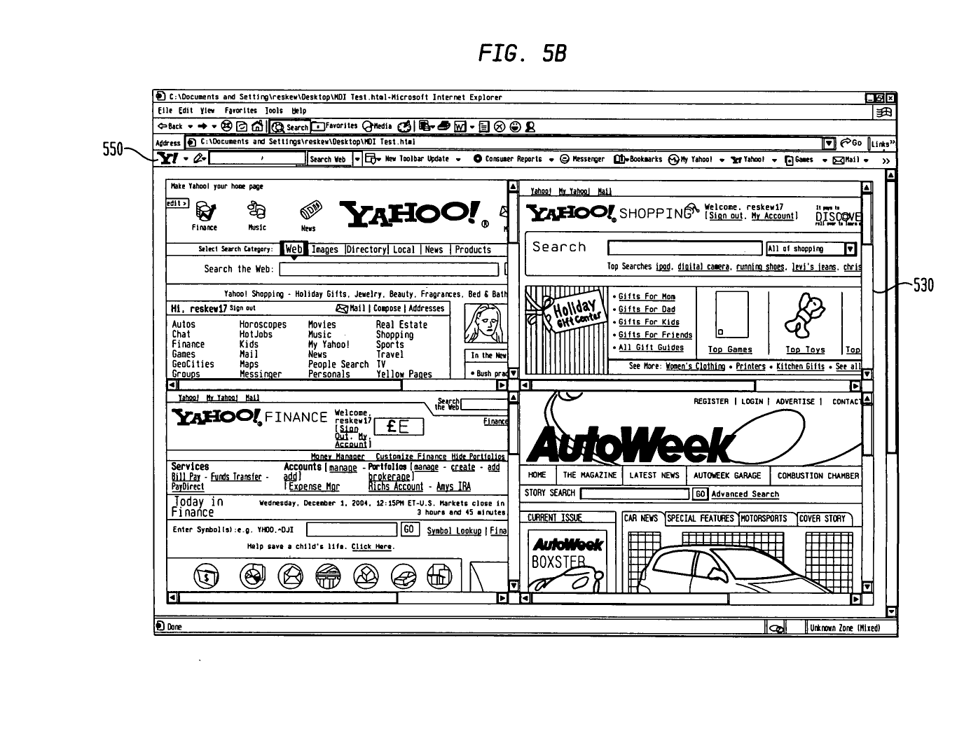

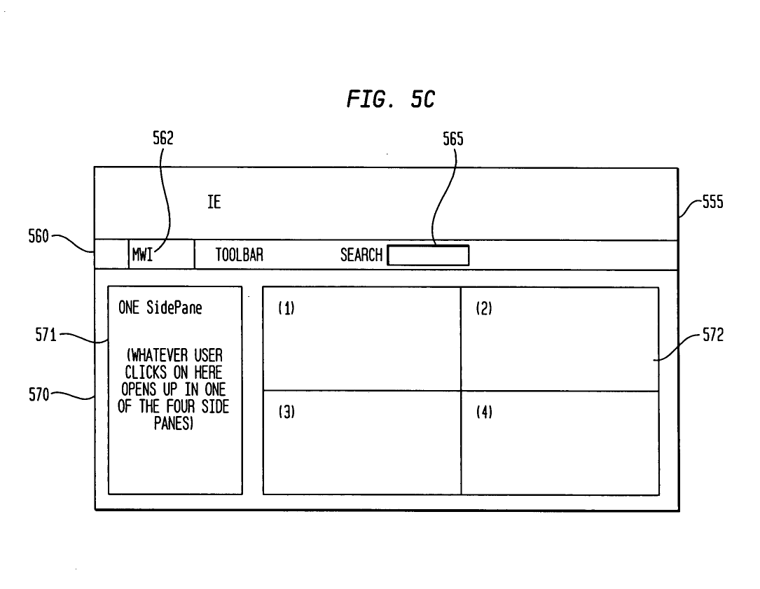

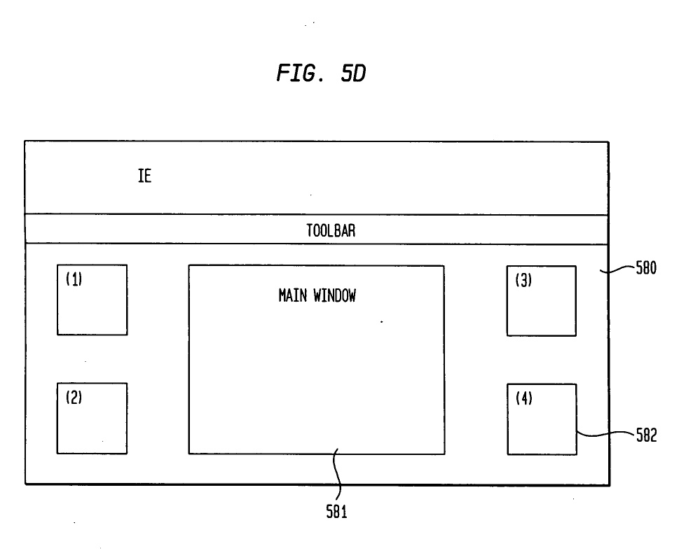

With reference to FIGS. 5-8, an embodiment of the present invention will be shown and described. Generally speaking, a software program, preferably but not necessarily in the form of a browser plug-in application, provides functionality to allow the creation of a multiple window browser interface environment, as shown in FIGS. 5a-5d for example. By way of example, when the software is activated, each time a user selects a URL to retrieve a new web site, the software displays a new browser window in addition to the existing browser window within a single instance of the web browser application, as opposed to displaying the new browser window in place of the existing browser window. The software, thus, permits users to view multiple browser windows in a side-by-side or tiled fashion in a single instance of the browser application.

Web sites are generally constructed using various forms of the Hypertext Mark-up Language (HTML). In order to create a frame or window division in a browser interface, a web site developer typically uses the “iframe” or “div” HTML tags. As used herein, the terms frame, division and window generally refer to a segment of a browser interface for displaying a web document, which may be defined by one or more fixed or movable stiles or rails or scrolling sliders. In order for a web site to take advantage of frames within a web site, the iframe or div tags are typically hard-coded into the HTML source code of the main web site page. As such, end users of a web site cannot take advantage of frames in a dynamic fashion to explore or compare multiple web sites in a multi-window environment.

Operation of the Multi-Window Application

In an embodiment of the present invention, a multi-window plug-in application controls the display of one or more window frames within a browser interface. The multi-window plug-in application can be hard-coded into the browser application, downloaded from a remote source to the browser application, or pushed from a remote source to the browser application. As is known in the art, a “plug-in” is typically a discrete software module that when incorporated into a larger application adds features to that application. Examples of plug-ins are media player plug-ins, such as the plug-in for Real® Player and Microsoft Windows® Media Player. The multi-window plug-in application of the present invention may be programmed in any known programming language including, by way of example, JavaScript or ActiveX.

In the embodiment being described, the multi-window plug-in application is designed to control the HTML code of a web page being viewed to take advantage of the framing functionality built into HTML. For example, as described above, HMTL permits web pages to include frames using the “iframe” or “div” tags. When the multi-window plug-in is activated, as described further below, new URL's that are selected by the user will cause HTML code to be generated by the multi-window plug-in that includes, in this example shown in FIG. 5a, two windows 510 and 520 in a single instance of the browser application 500. The first window 510 contains the initial web page that the user was viewing prior to selecting the URL and the second window 520 contains the web page corresponding to the new URL selected by the user. For example, as shown in FIG. 5a, a search was conducted in first window 510 that generated the list of results 515 displaying the first window 510. Upon selection of a result URL in first window 510, a second window 520 is created and both the first window 510 and the second window 520 are displayed in side-by-side fashion.

By way of example, the code generated by the multi-window plug-in application may look like the following:

EXAMPLE 1

<IFRAME
SRC=“http://search.yahoo.com/search?p=albert+einstein&sm=Yahoo
%21+Search&fr=FP-tab-web-t&toggle=1&ei=UTF-8” WIDTH=550
HEIGHT=650>
</IFRAME>
<IFRAME
SRC=“http://www.time.com/time/time100/poc/home.html”
WIDTH=550 HEIGHT=650>
</IFRAME>

The code in the Example 1 above produces the browser application interface 500 shown in FIG. 5a.

In an alternate embodiment, the multi-window plug-in application utilizes “div” functionality to create the window effect. DIV tags are HTML tags typically used to create logical delineations of the HTML contained within a browser window. As is known in the art, DIV tags comprise a start tag (“DIV”) and an end tag (“/DIV”). In a preferred embodiment of the multi-window interface, DIV tags are used to create each window of the interface. By enclosing a section of HTML layout code within the DIV tags, the window attributes can be set, for example, as follows: div: align (left, right, center), name, style. In this embodiment, HTML elements for creating the multi-window interface are preferably (although not necessarily) created dynamically using a scripting language, such as by way of non-limiting example, JavaScript or VBScript.

As an example, the following use cases will be described. In a first case, a static configuration is utilized in which the user chooses how to split the browser interface area is to be split. First, the user performs a search thereby causing a search page with results to be displayed in the browser window. The user then accesses the multi-window functionality, as detailed below, and selects one of the configuration options to decide how to configure the visible browser area. Some of the options could be a 1×4 view, as shown in FIG. 5c, or a central view as shown in FIG. 5d.

The search results page would be positioned in the main window such that subsequent clicks on any of the search results would cause the results page to open up in a new frame within the main window in a sequential manner, as shown in FIG. 5c.

In a second case, a dynamic mode can be utilized in which the main window is dynamically divided upon each click of a search result URL. In this case, a user searches in the search bar and the search results are displayed as usual. The user then enters the dynamic mode by accessing the multi-window functionality. Once in the dynamic mode, each time the user clicks on a search result, the browser interface is divided into an additional window with the selected URL loaded in that window.

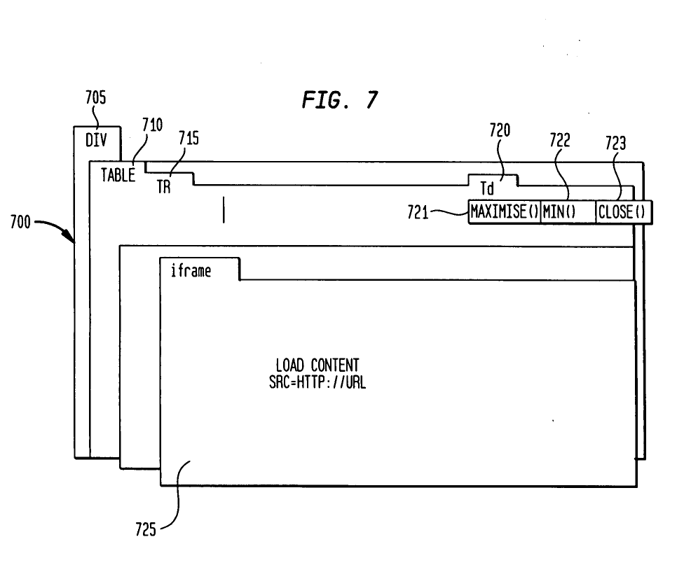

With reference now to FIG. 7, a schematic 700 of the preferred elements of a single window within the multi-window interface is shown. In a preferred embodiment using JavaScript to dynamically generate the windows, a JavaScript function is associated with each element of the window interface using HTML constructs. FIG. 7 thus depicts the following elements:

DIV=<div> element 705

Table=<table> element 710

Table Row <tr> 715

Table element <td> 720

Iframe=window URL 725

The table element 720, in the preferred embodiment of FIG. 7, includes a maximize( ) element 721, a minimize( ) element 722, and a close( ) element 723. Thus, in the above embodiment, customized scripted functions implement functionality for dragging the window or minimizing or maximizing the window, for example. The scripted function for minimizing the window may be invoked, for example, upon a mouse click of the mino element 722.

Illustrative Applications of the Multi-Window Plug-In Application

In a first embodiment, the multi-window plug-in application is triggered by or built into a toolbar application: An example of a toolbar application is disclosed in U.S. Published Application No. 2004US0165007, dated Aug. 26, 2004, the entire disclosure of which is incorporated herein by reference. In this instance, a multi-window plug-in application can be downloaded or pushed to a browser application as a discrete plug-in and incorporated as part of the functionality of the toolbar application. When the user makes use of the toolbar application, for example by performing a search using the toolbar 550 (shown in FIGS. 5a and 5b), the toolbar application triggers the functionality of the multi-window plug-in application. In this example, HTML code would be generated by the multi-window plug-in application to display the search results in a new window next to the existing window. In another instance, the multi-window plug-in application can be built-in to the toolbar application. This can be accomplished by dynamically updating the toolbar application or by releasing a new version of the toolbar application to be downloaded and installed by users. Once the toolbar application is updated to include the multi-window plug-in application, use of the toolbar to open a web page or perform a search would, according to the user's preferences, trigger the multi-window plug-in application functionality described above. The multi-window plug-in application can also be loaded as a discrete application independent of any toolbar application.

To illustrate, the functionality of the multi-window interface embedded as a plug-in a browser toolbar will now be described in connection with FIG. 5c. Preferably, a graphical toolbar button 562 is displayed on the browser toolbar 560 of browser interface 550. In general, the user can perform various operations on the toolbar 560, such as performing searches by entering search criteria in a search input box 565, saving bookmarks or favorites, accessing e-mail, and the like. When the user wishes to use the multi-window interface mode, the user clicks the multi-window interface button 562 on the toolbar 560 to initiates the multi-window interface mode. This initiation can be reflected, for example, in the button 562 by changing the image shown on the multi-window interface button 562 or by changing the color of the multi-window interface button 562.

In either case, the multi-window plug-in application preferably provides several options to the user for structuring the multi-window browser interface. As additional examples, as depicted in FIG. 5a, the multi-window interface may be limited to two windows and split either horizontally or vertically. In a second example, the user may be given the option to select any number of window divisions. For example, a side-by-side arrangement may be selected for a four window multi-window interface. In another example, as shown in FIG. 5b, a tiled arrangement 530 may be selected. In yet another example, the windows of the multi-window interface may be configured to overlap, float, or cascade. In such an embodiment, each window of the multi-window interface would preferably be movable within the browser application interface and have its own title bar and window controls. Of course, persons of skill will understand that the user can be given the choice of include any number of new windows in any configuration without limitation.

In a preferred embodiment, upon entering the multi-window interface mode, the user may again click the multi-window interface button 562 to access a configuration menu or a pop-up configuration dialog window. In this environment, the user can select the manner in which the multi-window interface will be configured. As an example, the user may select a 1×4 option which would provide a one main screen 571 (e.g., a side pane) with the remaining multi-window interface area 570 being divided into 4 panes 572 of equal size, as shown in FIG. 5c. In an alternate embodiment, the multi-window interface 580 can be configured as a large central frame 581 surrounded by four smaller frames 582, as is shown for example in FIG. 5d. Clicking any of the smaller side frames 582 would cause that frame to be displayed as the larger central frame 581.

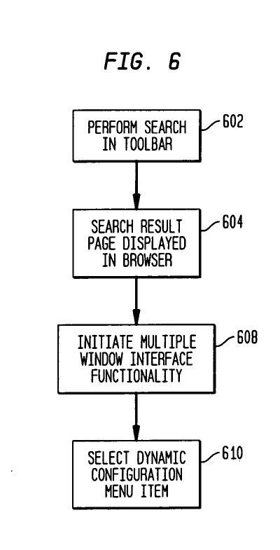

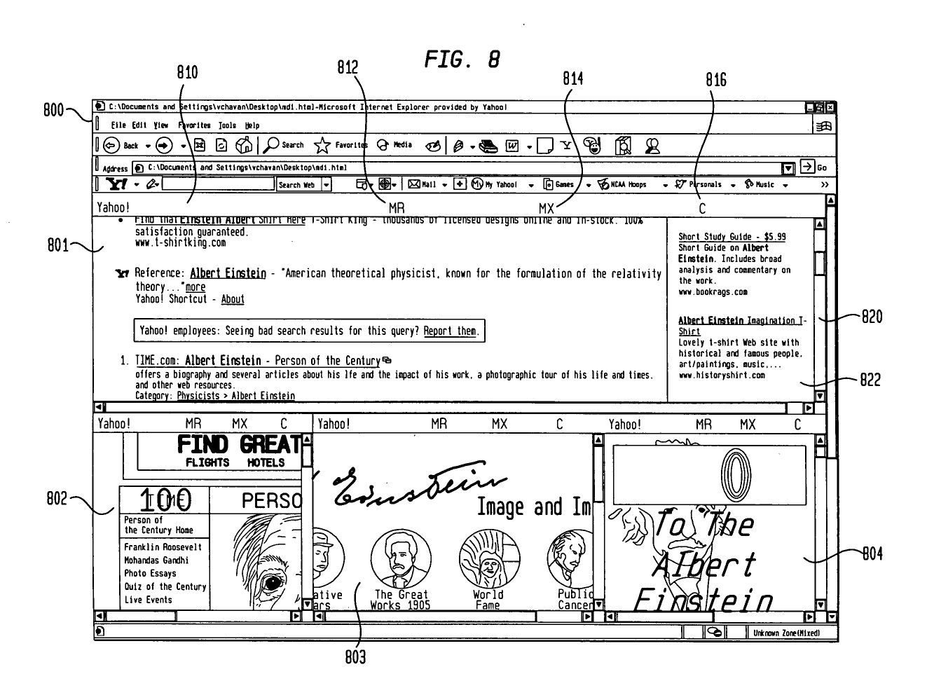

An example of an application of movable multi-window interface frames will be described in connection with a window configured as a 1×3 multi-window interface in which a web search was performed. In FIG. 6, in a first step 602, a user would search for Albert Einstein in the toolbar. The search would cause a search results page opens up in the browser, in step 604. Next, a user would access, in step 608, the multi-window interface functionality by clicking the multi-window interface button on the toolbar. In step 610, the user selects the dynamic configuration menu item. This triggers the movable multi-window interface functionality. Clicking on the first three search results causes the results pages to open as three separate panes, as shown in FIG. 8. In the example multi-window interface 800 shown in FIG. 8, each movable multi-window interface window 801, 802, 803, 804 has a title bar with MR 812, MX 814, and C 816, which respectively refer to “maximize”, “minimize”, and “close.” In addition to the title bar buttons 812, 814, 816, the user can click-and-hold the title bar 810 to drag the window anywhere in the client area. The user can also use the scroll bars 820 within each window to scroll the visible area 822. If the user wants to maximize a page to fit the whole screen, the user can, in addition to using the MX button, double click on the multi-window interface panel. If the user double clicks, for example, on this expanded panel, the panel is restored to its original size. Moreover, the user can freely resize any of the MDI. In a preferred embodiment, the software code for implementing this functionality, would be generated by the toolbar plug-in at runtime when user invokes the functionality through the toolbar.

The user is also preferably provided with the ability to customize how the windows of the multi-window interface are controlled. For example, if a user desired to perform a search and then compare various web pages retrieved as a result of the search, the first window, which would be the search window, would be set to control the opening of all new child windows. Thus, clicking a URL within the master search window would cause the display of a new child window showing the search result web page. If a user desired to navigate within the child window, the user could do so without further triggering the launch of new child windows. In the alternative, the user would be provided with the option to set each window to act as a master window such that each time a URL is selected in any window being displayed in the multi-window interface a new window would be created and displayed and positioned according to the user's preferences.

With reference to FIG. 5c, in an embodiment of the invention, such as when the multi-window plug-in application functions as part of a browser toolbar application, the toolbar application preferably includes a graphical icon for initiating the multi-window plug-in application functionality and/or accessing a customization interface, as described above. Persons of skill in the art will understand that the multi-window plug-in application functionality and customization interface can also be accessed via a text menu. Selecting (e.g., clicking) the button could function to toggle the multi-window functionality on or off as desired. Alternatively, the button could provide access to a menu that provides the user with several options including without limitation the option to turn the functionality on or off, set the number of permissible windows, set the window positioning or type, and designate one or more windows as master windows. Persons of skill in the art will recognize that additional options could be included within the scope of the present invention.

Thus, while there have been shown and described fundamental novel features of the invention as applied to the exemplary embodiments thereof, it will be understood that omissions and substitutions and changes in the form and details of the disclosed invention may be made by those skilled in the art without departing from the spirit of the invention. It is the intention, therefore, to be limited only as indicated by the scope of the claims appended hereto.

1. A multi-window plug-in application executable on a computer and operable with a browser application having an interface portion for displaying a first electronic document retrieved from a remote source, the multi-window plug-in application comprising:
a software module stored on a memory of a computer and executable to operate as a plug-in to the browser application to, in response to a request for a receive a second electronic document, generate browser readable programming code to cause the browser application to display the first electronic document in a first division of the interface portion of the browser application and the second electronic document in a second division of the interface portion of the browser application so as to display said first electronic document and said second electronic document simultaneously via said browser.

2. The multi-window plug-in application of claim 1, wherein the first and second electronic documents are each retrieved from the Internet.

3. The multi-window plug-in application of claim 1, wherein the first and second electronic documents are each retrieved from the World Wide Web.

4. The multi-window plug-in application of claim 1, wherein the software module of the multi-window plug-in application is downloaded to the computer.

5. The multi-window plug-in application of claim 1, wherein the browser readable programming code is HTML.

6. The multi-window plug-in application of claim 1, wherein the browser readable programming code is ActiveX script.

7. The multi-window plug-in application of claim 1, wherein the browser readable programming code is JavaScript.

8. The multi-window plug-in application of claim 1, wherein said multi-window plug-in application is part of a toolbar application.

9. The multi-window plug-in application of claim 1, wherein divisions of the interface portion of the browser application are movable.

10. The multi-window plug-in application of claim 1, wherein divisions of the interface portion of the browser application comprise a title bar and associated controls for permitting the user to manipulate the display of each of the plurality of electronic documents.

11. The multi-window plug-in application of claim 10, wherein manipulation of said divisions comprises at least one of maximizing, minimizing, closing and moving said divisions.

12. The multi-window plug-in application of claim 1, wherein the software module is further operative to receive one or more additional requests to retrieve additional electronic documents from one or more remote sources and generate browser readable programming code to cause the browser application to display each of the additional electronic documents in a division of the interface portion of the browser application.

13. The multi-window plug-in application of claim 12, wherein the additional electronic documents are displayed in a tile arrangement.

14. The multi-window plug-in application of claim 12, wherein the additional documents are displayed in a side-by-side vertical arrangement.

15. The multi-window plug-in application of claim 12, wherein the additional documents are displayed in a side-by-side horizontal arrangement.

16. The multi-window plug-in application of claim 12, wherein at least one of said divisions of the interface portion of the browser application is a master window, and wherein electronic documents retrieved in response to requests to retrieve additional electronic documents initiated from a master window are displayed in another division of the interface portion of the browser application.

17. The multi-window plug-in application of claim 16, wherein at least one search result is displayed in the master window, and wherein an electronic documents selected from the at least one search results is displayed in another division of the interface portion of the browser application.

18. The multi-window plug-in application of claim 12, wherein at least one of said divisions of the interface portion of the browser application is a child window, and wherein electronic documents retrieved in response to requests to retrieve additional electronic documents initiated from a child window are displayed in the child window.

19. An application executable on a computer and operable with a browser having an interface portion for displaying a first electronic document retrieved from a remote source, the application comprising:
a software module executable on said computer, said software module, in response to a request through said browser to receive a second electronic document, generating browser readable programming code to cause the browser to display the first electronic document in a first division of the interface portion of the browser and the second electronic document in a second division of the interface portion of the browser, such that said first electronic document and said second electronic document are simultaneously visible via said browser without the need to instantiate a second browser.

20. The application of claim 19, wherein the first and second electronic documents are each retrieved from the Internet.

21. The application of claim 19, wherein the first and second electronic documents are each retrieved from the World Wide Web.

22. The application of claim 19, wherein the software module is downloaded to the computer.

23. The application of claim 19, wherein the browser readable programming code is HTML.

24. The application of claim 19, wherein the browser readable programming code is ActiveX script.

25. The application of claim 19, wherein the browser readable programming code is JavaScript.

26. The application of claim 19, wherein said multi-window plug-in application is part of a toolbar application.

27. The application of claim 19, wherein divisions of the interface portion of the browser application are movable.

28. The application of claim 19, wherein divisions of the interface portion of the browser application comprise a title bar and associated controls for permitting the user to manipulate the display of each of the plurality of electronic documents.

29. The application of claim 28, wherein manipulation of said divisions comprises at least one of maximizing, minimizing, closing and moving said divisions.

30. The application of claim 19, wherein the software module is further operative to receive one or more additional requests to retrieve additional electronic documents from one or more remote sources and generate browser readable programming code to cause the browser application to display each of the additional electronic documents in a division of the interface portion of the browser application.

31. The application of claim 30, wherein the additional electronic documents are displayed in a tile arrangement.

32. The application of claim 30, wherein the additional documents are displayed in a side-by-side vertical arrangement.

33. The application of claim 30, wherein the additional documents are displayed in a side-by-side horizontal arrangement.

34. The application of claim 30, wherein at least one of said divisions of the interface portion of the browser application is a master window, and wherein electronic documents retrieved in response to requests to retrieve additional electronic documents initiated from a master window are displayed in another division of the interface portion of the browser application.

35. The application of claim 30, wherein at least one of said divisions of the interface portion of the browser application is a child window, and wherein electronic documents retrieved in response to requests to retrieve additional electronic documents initiated from a child window are displayed in the child window.

36. A computer-readable storage medium containing a set of instructions for a general purpose computer for comparing a plurality of electronic documents displayed in a single instance of a browser application, the instructions comprising:
a multiple window interface routine operatively associated with the browser application and receiving a request input by a user to display the plurality of documents in a selected arrangement, the multiple interface routine generating application code to cause the browser to display the plurality of electronic documents in the selected arrangement such that the plurality of electronic documents are simultaneously visible via said browser without the need to instantiate a second browser.

37. The computer readable storage medium of claim 36, wherein said electronic documents are retrieved from the Internet.

38. The computer readable storage medium of claim 36, wherein said electronic documents are retrieved from the World Wide Web.

39. The computer readable storage medium of claim 36, wherein said instructions are downloaded onto said computer readable storage medium.

40. The computer readable storage medium of claim 36, wherein the application code is HTML.

41. The computer readable storage medium of claim 36, wherein the application code is ActiveX script.

42. The computer readable storage medium of claim 36, wherein the application code is JavaScript.

43. The computer readable storage medium of claim 36, further containing a set of instructions for a general purpose computer for a toolbar application, wherein the set of instructions for a general purpose computer for comparing a plurality of electronic documents displayed in a single instance of a browser application works with said toolbar application.

44. The computer readable storage medium of claim 36, wherein the instructions further comprising:
a dynamic display routine for generating application code to permit the browser application to dynamically display additional electronic documents in the single instance of the browser application.

45. The computer readable storage medium of claim 44, wherein the additional electronic documents are displayed in a tile arrangement.

46. The computer readable storage medium of claim 44, wherein the additional documents are displayed in a side-by-side vertical arrangement.

47. The computer readable storage medium of claim 44, wherein the additional documents are displayed in a side-by-side horizontal arrangement.

48. The computer readable storage medium of claim 44, wherein said browser displays said plurality of electronic documents in multiple windows, and wherein at least one of said multiple windows is a master window, and wherein electronic documents retrieved in response to requests to retrieve additional electronic documents initiated from a master window are displayed in another window.

49. The computer readable storage medium of claim 44, wherein said browser displays said plurality of electronic documents in multiple windows, and wherein at least one of said windows is a child window, wherein electronic documents retrieved in response to requests to retrieve additional electronic documents initiated from a child window are displayed in the child window.

50. The computer readable storage medium of claim 44, wherein said browser displays said plurality of electronic documents in multiple windows, and wherein said multiple windows are movable.

51. The computer readable storage medium of claim 44, wherein the instructions further comprising:
a second dynamic display routine for generating application code to permit each of the plurality of electronic documents to include a title bar and associated controls for permitting the user to manipulate the display of each of the plurality of electronic documents.

52. The computer readable storage medium of claim 51, wherein manipulation of said display comprises at least one of maximizing, minimizing, closing and moving said display.

53. A method of comparing a plurality of electronic documents of a search result retrieved by a browser application and displayed in an interface, the method comprising:
receiving a first request to retrieve a first electronic document of the plurality of electronic documents corresponding to a first link listed in the search result;
receiving a second request to retrieve a second electronic document of the plurality of electronic documents corresponding to a second link listed in the search result; and
generating browser readable programming code to display each of the search result, the first electronic document, and the second electronic document in the interface of the browser application.

54. The method of claim 53, wherein the first and second electronic documents are each retrieved from the Internet.

55. The method of claim 53, wherein the first and second electronic documents are each retrieved from the World Wide Web.

56. The method of claim 53, further comprising downloading a set of instructions for a general purpose computer for comparing said plurality of electronic documents of said search result retrieved by said browser application and displayed in said interface.

57. The method of claim 53, wherein the browser readable programming code is HTML.

58. The method of claim 53, wherein the browser readable programming code is ActiveX script.

59. The method of claim 53, wherein the browser readable programming code is JavaScript.

60. The method of claim 53, further comprising receiving a search term for said search result from a toolbar application.

61. The method of claim 53, wherein the position of each of the search result, the first electronic document, and the second electronic document divisions within the interface portion of the browser is user controlled.

62. The method of claim 53, further comprising receiving one or more additional requests to retrieve additional electronic documents from one or more remote sources and generating browser readable programming code to cause the browser application to display each of the additional electronic documents in a division of the interface portion of the browser application.

63. The method of claim 62, wherein the additional electronic documents are displayed in a tile arrangement.

64. The method of claim 62, wherein the additional documents are displayed in a side-by-side vertical arrangement.

65. The method of claim 62, wherein the additional documents are displayed in a side-by-side horizontal arrangement.

66. The method of claim 62, further comprising displaying an electronic document, retrieved in response to requests to retrieve additional electronic documents initiated from a master window, in another window.

67. The method of claim 62, further comprising displaying an electronic document, retrieved in response to requests to retrieve additional electronic documents initiated from a child window, in the child window.

68. The method of claim 62, further comprising generating browser readable programming code to rearrange the display of the electronic documents in response to a user request.

69. The method claim 62, further comprising generating browser readable programming code to include a title bar and associated controls for permitting the user to manipulate the display of each of the plurality of electronic documents.

70. The method of claim 69, wherein manipulation of said display comprises at least one of maximizing, minimizing, closing and moving said display.

71. A graphical user interface for a general purpose computer for comparing a plurality of electronic documents displayed in a single instance of a browser application, the interface comprising:
a dynamic display, controlled by a multiple window interface routine operatively associated with the browser application, the multiple interface routine generating application code to cause the dynamic display to display the plurality of electronic documents in a selected arrangement, such that the plurality of electronic documents are simultaneously visible via said browser without the need to instantiate a second browser.

72. The graphical user interface of claim 71, wherein said electronic documents are retrieved from the Internet.

73. The graphical user interface of claim 71, wherein said electronic documents are retrieved from the World Wide Web.

74. The graphical user interface of claim 71, wherein said multiple window interface routine is downloaded onto said computer.

75. The graphical user interface of claim 71, wherein the application code is HTML.

76. The graphical user interface of claim 71, wherein the application code is ActiveX script.

77. The graphical user interface of claim 71, wherein the application code is JavaScript.

78. The graphical user interface of claim 71, further comprising a toolbar application integrated into said browser.

79. The graphical user interface of claim 71, wherein the plurality of electronic documents are displayed in a tile arrangement.

80. The graphical user interface of claim 71, wherein the plurality of documents are displayed in a side-by-side vertical arrangement.

81. The graphical user interface of claim 71, wherein the plurality of documents are displayed in a side-by-side horizontal arrangement.

82. The graphical user interface of claim 71, wherein said graphical user interface displays said plurality of electronic documents in multiple windows, and wherein at least one of said multiple windows is a master window, and wherein electronic documents retrieved in response to requests to retrieve additional electronic documents initiated from a master window are displayed in another window.

83. The graphical user interface of claim 71, wherein said graphical user interface displays said plurality of electronic documents in multiple windows, and wherein at least one of said windows is a child window, wherein electronic documents retrieved in response to requests to retrieve additional electronic documents initiated from a child window are displayed in the child window.

84. The graphical user interface of claim 71, wherein said graphical user interface displays said plurality of electronic documents in multiple windows, and wherein said multiple windows are movable.

85. The graphical user interface of claim 71, wherein said graphical user interface displays said plurality of electronic documents in multiple windows, and wherein said windows comprise a title bar and associated controls for permitting the user to manipulate the display of each of the plurality of electronic documents.

86. The graphical user interface of claim 85, wherein manipulation of said windows comprises at least one of maximizing, minimizing, closing and moving said display.
